(19) United States
(12) Patent Application Publication
(10) Pub. No.: US 2020/0007028 A1
(43) Pub. Date: Jan. 2, 2020

(54) POWER SUPPLY FOR SUBMODULE CONTROLLER OF MMC CONVERTER

(71) Applicant: HYOSUNG HEAVY INDUSTRIES CORPORATION, Seoul (KR)

(72) Inventors: Jung Won HONG, Bucheon-si, Gyeonggi-do (KR); Yong Hee PARK, Anyang-si, Gyeonggi-do (KR); Joo Yeon LEE, Seoul (KR)

(21) Appl. No.: 16/473,484

(22) PCT Filed: Dec. 6, 2017
(86) PCT No.: PCT/KR2017/014183

§ 371 Date: Jun. 25, 2019

(30) Foreign Application Priority Data
Dec. 26, 2016 (KR) 10-2016-0179557

(51) Int. Cl. H02M 1/32; H02M 7/483; H02J 3/36

(52) U.S. Cl. CPC H02M 1/32; H02M 2001/325; H02J 3/36; H02M 7/483

(57) ABSTRACT

A power supply for a submodule controller of an MMC converter, which supplies driving power to a submodule controller of an MMC connected to an HVDC system. The power supply includes: a bridge circuit unit including an energy storage unit storing a DC voltage of a series-connected submodule of the MMC converter, and multiple power semiconductor devices connected in parallel to the energy storage unit in a bridge form; a first resistor unit connected in parallel to the energy storage unit, and configured with at least one series-connected resistor; a second resistor unit connected in series to the first resistor unit; a switch unit connected in parallel to the first resistor unit; and a DC/DC converter converting a voltage output from output terminals formed in both ends of the second resistor unit into a low voltage, and supplying the same to the submodule controller.

### TECHNICAL FIELD

The present invention relates to a power supply for a submodule controller. More particularly, the present invention relates to a power supply for a submodule controller of a modular multilevel converter (MMC), which supplies driving power to a submodule controller of an MMC converter connected to a high voltage direct current (HVDC) system.

### BACKGROUND ART

Generally, in HVDC systems, alternating current (AC) power generated in a power plant is converted into DC power and then the DC power is transmitted, and a power receiving stage re-converts the DC power into AC power and supplies the same to a load. The above HVDC system is advantageous in that power may be efficiently and economically transmitted through voltage boosting, and in that connection between heterogeneous systems and long-distance high-efficiency power transmission are possible.

A MMC converter is connected to an HVDC system for power transmission and reactive power compensation. In the above MMC converter, multiple submodules are connected in series with each other. In the MMC converter, submodules are very important components and are controlled by a controller that is separately provided. In order to use the high voltage from submodules as driving power for the submodule controller, a power supply is required for the submodule controller where the high voltage is converted into a low voltage.

FIG. 1 is a view showing an equivalent circuit diagram of an MMC converter, and FIG. 2 is a view showing a circuit diagram of a conventional power supply for a submodule controller of an MMC converter. As is well-known in the art, the MMC converter is configured with at least one phase module 1, and multiple series-connected submodules 10 are connected in each phase module 1. In addition, DC voltage terminals of each phase module 1 are respectively connected to positive (+) and negative (−) DC voltage bars which are P and N bars. A high DC voltage is present between the DC voltage bars P and N. Each submodule 10 is formed with two connection terminals X1 and X2.

A conventional power supply 20 for a submodule controller of an MMC converter includes: two power semiconductor devices 21 and 21 formed in a half bridge form; an energy storage unit 23 connected in parallel to the power semiconductor devices; and a DC/DC converter 25 connected to a resistor 24 that is connected in parallel to the energy storage unit 23.

When the above power supply 20 for the submodule controller is applied to an MMC converter that is connected to an HVDC system, a high voltage of several to several tens of kV stored in the energy storage unit 23 has to be converted into a low voltage of several to several tens of V required for the submodule controller.

However, in the conventional art, when an over voltage occurs in the high voltage of several to several tens of kV stored in the energy storage unit 23, the DC/DC converter 25 may be damaged by receiving a voltage exceeding an input range.

Accordingly, the specification of the input voltage of the DC/DC converter 25 has to be improved, and the cost of the DC/DC converter is increased by applying a converter with an unnecessary high specification so as to take into account the over voltage range.

### DISCLOSURE

### Technical Problem

Accordingly, an objective of the present invention is to provide a power supply for a submodule controller of an MMC converter, which prevents failure due to an internal over voltage without applying a part with an unnecessary high specification when supplying control power to the submodule controller, wherein multiple submodules of an MMC converter connected to an HVDC system receive an internal high voltage, and the received voltage is converted into a low voltage for driving the submodule controller.

### Technical Solution

According to an embodiment of the present invention, a power supply for a submodule controller of an MMC converter includes: a bridge circuit unit including an energy storage unit storing a DC voltage of a series-connected submodule of the MMC converter, and multiple power semiconductor devices connected in parallel to the energy storage unit in a bridge form; a first resistor unit connected in parallel to the energy storage unit, and configured with at least one series-connected resistor; a second resistor unit connected in series to the first resistor unit; a switch unit connected in parallel to the first resistor unit; and a DC/DC converter converting a voltage output from output terminals formed in both ends of the second resistor unit into a low voltage, and supplying the same to the submodule controller.

In the present invention, the switch unit may be turned on so as to form a bypass circuit in the first resistor unit when a voltage detected in the energy storage unit is equal to or smaller than a preset voltage.

According to another embodiment of the present invention, a power supply for a submodule controller of an MMC converter includes: a bridge circuit unit including an energy storage unit storing a DC voltage of a series-connected submodule of the MMC converter, and multiple power semiconductor devices connected in parallel to the energy storage unit in a bridge form; a first resistor unit configured with N series-connected resistors that are connected in parallel to the energy storage unit; a second resistor unit connected in series to the first resistor unit; a switching unit configured with N switches respectively connected in parallel to the N resistors constituting the first resistor unit; and a DC/DC converter converting a voltage output from output terminals formed in both ends of the second resistor unit into a low voltage, and supplying the same to a submodule controller.

In the present invention, n switches of the switching unit which are respectively connected in parallel to n resistors (n≤N) may be turned on so as to form a bypass circuit in the n resistors among the N resistors constituting the first resistor unit according to a voltage detected in the energy storage unit.

In the present invention, the n switches of the switching unit may be turned on by setting an n value such that a number of the first resistors in which the bypass circuit is formed among the N resistors constituting the first resistor unit becomes smaller when the voltage detected in the energy storage unit is larger.

In the present invention, the bridge circuit may include any one selected from a half bridge circuit or a full bridge circuit.

### Advantageous Effects

A power supply for a submodule controller of an MMC converter according to the present invention can stably operate under an over voltage state without improving an input voltage specification of an internal DC/DC converter.

In addition, according to the present invention, a voltage dividing value in association with an over voltage is selected by providing multiple voltage dividing resistors and a bypass circuit for the same, and thus the over voltage can be accurately controlled.

### DESCRIPTION OF DRAWINGS

FIG. 1 is a view showing an equivalent circuit diagram of an MMC converter.

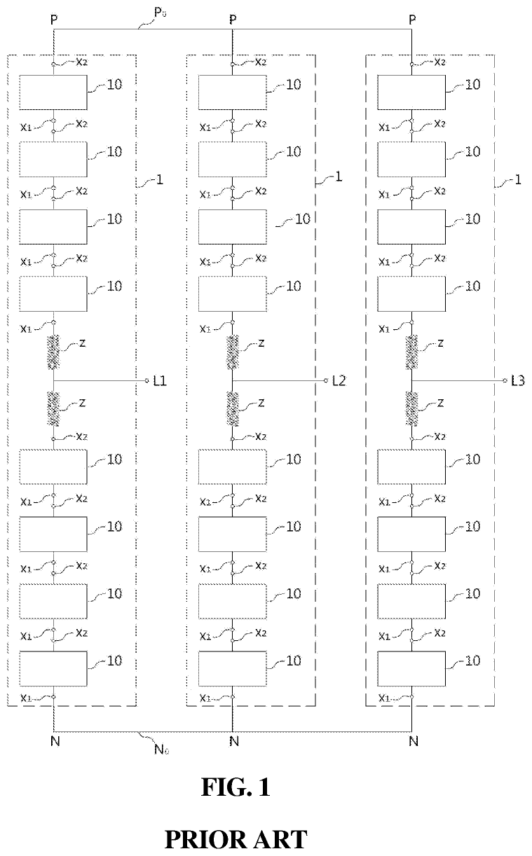

FIG. 2 is a view showing a circuit diagram of a conventional power supply for a submodule controller of an MMC converter.

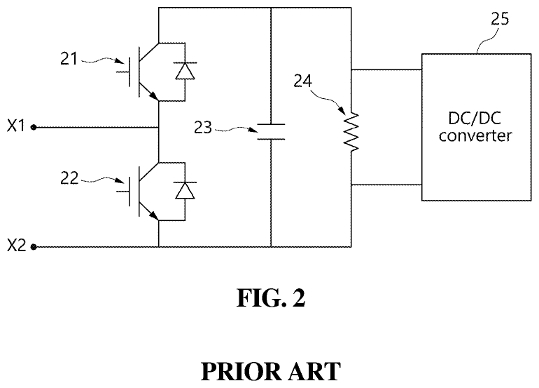

FIG. 3 is a view showing a circuit diagram of a power supply for a submodule controller of an MMC converter according to an embodiment of the present invention.

FIG. 4 is a view showing a circuit diagram of a power supply for a submodule controller of an MMC converter according to another embodiment of the present invention.

### BEST MODE

Hereinafter, embodiments of the present disclosure will be described in detail with reference to the accompanying drawings. According to the reference markings of the components of such figures, attention should be given to using the equivalent marking(s), when possible as similar components in the figurative representation are highlighted. Also, according to the explanation of the present invention, a detailed explanation is omitted in the case where a concrete explanation regarding notified components and/or functions is determined to be lacking unnecessary.

Further, terms such as first, second, A, B, (a), and (b) may be used to describe the components of the present invention. The terms are provided only for discriminating components from other components and, the essence, sequence, or order of the components are not limited by the terms. When a component is described as being “connected”, “combined”, or “coupled” with another component, it should be understood that the component may be connected or coupled to another component directly or with another component interposing therebetween.”

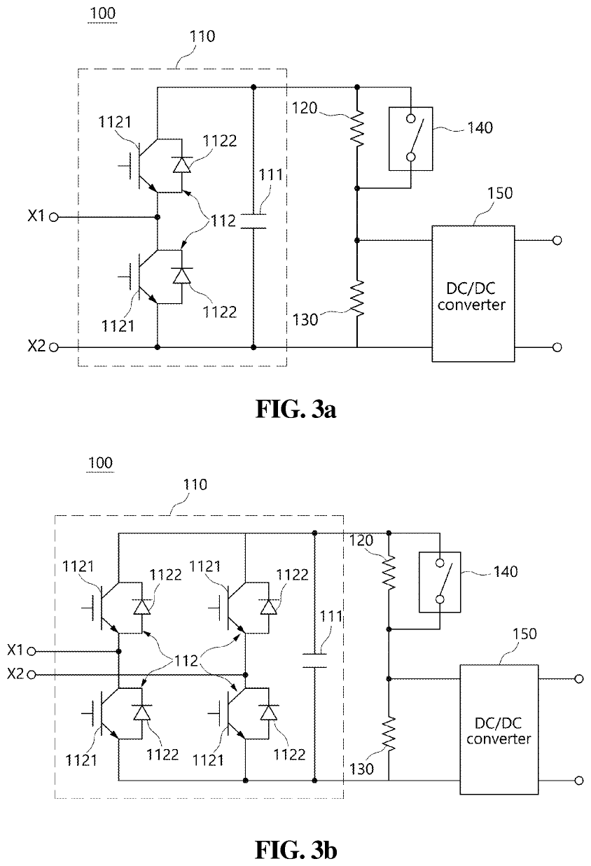

FIGS. 3a and 3b are views respectively showing circuit diagrams of a power supply for a submodule controller of an MMC converter according to an embodiment of the present invention.

A power supply 100 for a submodule controller of an MMC converter according to the present embodiment is applied to an MMC converter having at least one phase module. Each phase module includes multiple series-connected submodules, and DC voltage terminals thereof are respectively connected to positive (+) and negative (−) terminals of DC voltage bars which are P and N bars. The multiple submodules are connected in series with each other through two input terminals X1 and X2, and store a DC voltage in an energy storage unit 111 connected in series. Operation of the above submodules is controlled by a controller (not shown), and the power supply 100 according to the present invention converts a high voltage (several to several tens of kV), stored in the energy storage unit 111, into a low voltage (several to several tens of V), and supplies the low voltage to the submodule controller as driving power.

The power supply 100 according to the embodiment of the present invention includes a bridge circuit unit 110, a first resistor unit 120, a second resistor unit 130, a switch unit 140, and a DC/DC converter 150.

The bridge circuit unit 110 includes an energy storage unit 111 and multiple power semiconductor devices 112. The energy storage unit 111 stores a DC voltage.

The multiple power semiconductor devices 112 are connected in parallel to the energy storage unit 111 in a bridge form. In the present embodiment, the bridge circuit unit 110 may include a half bridge circuit or a full bridge circuit.

In addition, the energy storage unit 111 is a device for storing a DC voltage and may be implemented by using, for example, a capacitor or the like. The power semiconductor device 112 is a device for switching the current flow, and may be implemented by using, for example, an insulated-gate bipolar transistor (IGBT), a field effect transistor (FET), or a transistor, etc.

FIG. 3a shows an example where the energy storage unit 111 and the multiple power semiconductor devices 112 constitute a half bridge circuit, and FIG. 3b shows an example where the energy storage unit 111 and the multiple power semiconductor devices 112 constitute a full bridge circuit.

In detail, in an example of the half bridge circuit shown in FIG. 3a, two series-connected power semiconductor devices 112 are connected in parallel to the energy storage unit 111, thus constituting the half bridge circuit.

Each of the power semiconductor devices 112 includes a turn on/off controllable power semiconductor switch 1121 and a free-wheeling diode 1122 connected in parallel to the power semiconductor switch 1121.

Each power semiconductor device 112 is turned on/turned off by a control signal of a controller (not shown).

In addition, a first input terminal X1 and a second input terminal X2 are formed at both ends of any one of the two power semiconductor devices 112 of the half bridge circuit, and thus are connected in series with other submodules. Although two power semiconductor devices 112 are shown in the figure as an example, the present invention is not limited thereto.

In an example of the full bridge circuit shown in FIG. 3b, two series-connected pairs of two parallel-connected power semiconductor devices 112 are respectively connected in parallel to the energy storage unit 111, thus constituting the full bridge circuit.

The power semiconductor devices 112 may be turned on/turned off by a control signal of a controller (not shown).

In addition, in the full bridge circuit, a first input terminal X1 and a second input terminal X2 are formed at respective junctions of the power semiconductor devices 112 forming each pair. Although four power semiconductor devices 112 are shown in the figure as an example, the present invention is not limited thereto.

The first resistor unit 120 is connected in parallel to the energy storage unit 111, and configured with at least one series-connected resistor.

For the convenience of description, in an example shown in FIGS. 3a and 3b, the first resistor unit 120 is configured with one resistor.

The second resistor unit 130 is connected in series to the first resistor unit 120, and the first resistor unit 120 and the second resistor unit 130 are connected in parallel to the energy storage unit 111 while being connected in series with each other.

The first resistor unit 120 is connected to the switch unit 140 at both ends thereof.

For the switch unit 140, a single pole single throw (SPST) formed switch is applied, and the switch is turned on/turned off.

When the switch unit 140 is turned on, both ends of the first resistor unit 120 become short to form a bypass circuit such that the first resistor unit 120 is separated from the circuit, and thus the DC voltage stored in the energy storage unit 111 is transferred to the second resistor unit 130.

However, when the switch unit 140 is turned off, the bypass circuit formed in both ends of the first resistor unit 120 becomes open, and thus the DC voltage stored in the energy storage unit 111 is divided by the first resistor unit 120 and the second resistor unit 130.

The switch unit 140 may be implemented by using, for example, a semiconductor switch such as insulated-gate bipolar transistor (IGBT), field effect transistor (FET), or a transistor, etc., and by using a mechanical switch such as relay, etc.

The DC/DC converter 150 converts the voltage output from the output terminal formed in both ends of the second resistor unit 130 into a low voltage, and supplies the same to the submodule controller (not shown).

Accordingly, the DC/DC converter 150 may receive the voltage divided by the first resistor unit 120 according to an off state of the switch unit 140 through the second resistor unit 130, or may receive the voltage that is not divided by the bypass circuit formed in the first resistor unit 120 according to an on state of the switch unit 140 through the second resistor unit 130.

The switch unit 140 is turned on/turned off according to the voltage of the energy storage unit 111.

When the voltage stored in the energy storage unit 111 does not exceed a preset voltage, the switch unit 140 is turned on so as to form the bypass circuit in the first resistor unit 120 such that the voltage stored in the energy storage unit 111 is not divided and supplied to the DC/DC converter 150 through the second resistor unit 130.

When the voltage stored in the energy storage unit 111 is detected to exceed the preset voltage, the switch unit 140 is turned off so as to remove the bypass circuit formed in the first resistor unit 120 such that the voltage stored in the energy storage unit 111 is divided by the first resistor unit 120 and the second resistor unit 130, and the voltage at the ends of the second resistor unit 130 is supplied to the DC/DC converter 150.

As described above, the power supply 100 according to an embodiment of the present invention supplies driving power to the submodule controller by using the high voltage stored in the energy storage unit 111 that is provided inside the submodule of the MMC converter. However, when a over voltage occurs in the high voltage stored in the energy storage unit 111g, a preset partial voltage of the high voltage is supplied to the DC/DC converter 150 by dividing the high voltage through the first resistor unit 120 and the second resistor unit 130. The DC/DC converter 150 converts the supplied voltage into a low voltage, and supplies the same as the driving power of the submodule controller.

When the over voltage does not occur in the high voltage stored in the energy storage unit 111, the switch unit 140 is turned on so as to form a bypass circuit in the first resistor unit 120 such that the high voltage stored in the energy storage unit 111 is supplied to the DC/DC converter 150 through the second resistor unit 130 without being divided. Therefore, controlling voltage division due to the over voltage is performed only when necessary.

Accordingly, damage to the DC/DC converter 150 due to the over voltage occurring in conventional art can be prevented, and it is not necessary to improve the specification of the DC/DC converter to have a large range of input voltage by taking into account the over voltage, and thus monetary losses can be reduced.

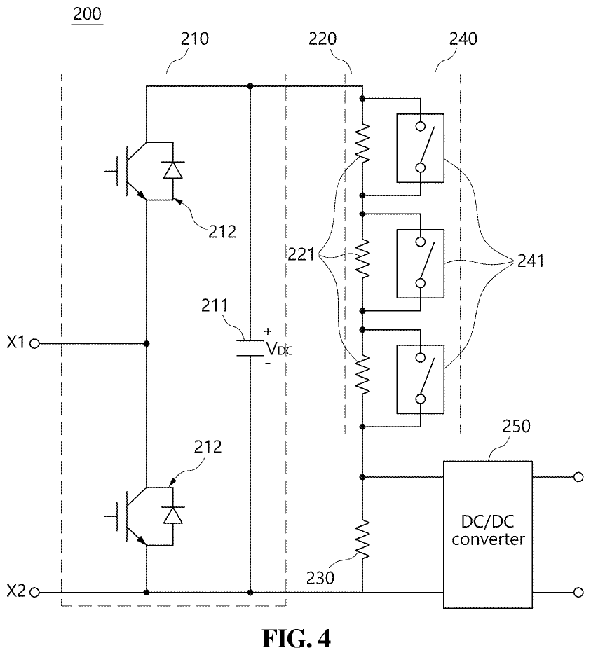

FIG. 4 is a view of a circuit diagram of a power supply for a submodule controller of an MMC converter according to another embodiment of the present invention.

A power supply 200 for a submodule controller of an MMC converter according to another embodiment of the present invention includes a bridge circuit unit 210, a first resistor unit 220, a second resistor unit 230, a switch unit 240, and a DC/DC converter 250.

The bridge circuit unit 210, the second resistor unit 230, and the DC/DC converter 250 are identical to the bridge circuit unit 110, the second resistor unit 130, and the DC/DC converter 150 of FIG. 3, respectively.

Accordingly, the bridge circuit unit 210 may be implemented in a half bridge circuit or full bridge circuit by using an energy storage unit 211 and multiple power semiconductor devices 212.

For the convenience of description, in an example shown in FIG. 4, the bridge circuit unit 210 is implemented in a half bridge circuit.

However, the power supply 200 shown in FIG. 4 differs from the power supply 100 shown in FIG. 3 in that the first resistor unit 220 is configured with a plurality of series-connected resistors 221, and the switch unit 140 is configured with a plurality of switches which are respectively connected in parallel to the resistors 221 constituting the first resistor unit 220. The above configuration will be described in detail below.

The power supply 200 according to another embodiment of the present invention includes the first resistor unit 220 where N resistors 221 are serially connected, and the switch unit 240 including N switches 241 which are respectively connected in parallel to both ends of respective N resistors 221 constituting the first resistor unit 220.

n switches 241 of the switch unit 240 which are respectively connected to n resistors 241 in parallel are turned on so as to form each bypass circuit in n (n≤N) resistors among N resistors constituting the first resistor unit 220 according to a voltage detected in the energy storage unit 211.

For the convenience of description, in an example shown in FIG. 4, N is set as N=3, and thus the first resistor unit 220 is configured with three series-connected resistors 221, and three switches 241 are respectively connected to the resistors 221 which constitute the switch unit 240.

In other words, the energy storage unit 221 is connected in parallel to four resistors at both ends thereof, which are three resistors 221 constituting the first resistor unit 220 and one resistor constituting the second resistor unit 230.

The DC/DC converter 250 receives a voltage output through the second resistor unit 230, and a voltage value input to the DC/DC converter 250 varies according to a voltage division ratio where the voltage division ratio varies according to how many bypass circuits are formed in the resistors 221 among three resistors 221 by the switch unit 240.

In other words, the voltage value input to the DC/DC converter 250 may be controlled by adjusting the voltage division ratio according to setting of an n value.

Representing the input voltage of the DC/DC converter 250 according to setting of the n value by using an equation, when resistor values of N resistors constituting the first resistor unit 220 are all equal to R1, a resistor value of the second resistor unit 230 is R2, and a voltage value stored in the energy storage unit 211 is V_{DC}, the input voltage V_{dc} of the DC/DC converter 250 according to operations of n switches may be represented as Equation 1 below.

$${V}_{dc} = {V}_{DC} \times \frac{R 2}{( N - n ) R 1 + R 2} ( 0 \leq n \leq N ) \qquad [ Equation 1 ]$$

In Equation 1, when a value of N is fixed, a value of V_{dc} becomes small when n becomes small as the value of the denominator becomes larger at the voltage division ratio. Accordingly, in order to maintain a constant value of V_{dc}, when the value of V_{DC} increases, the n value is decreased so that the V_{dc} value is lowered to be maintained at a constant level.

When the voltage value V stored in the energy storage unit 211 is detected to exceed a preset range and thus an over voltage is detected, the n value is set in association with an input voltage range of the DC/DC converter 250, and the switches 241 of the switching unit 240 are controlled such that the division ratio of the voltage is adjusted according to the set n value.

When the voltage detected in the energy storage unit 211 is equal to or smaller than the preset voltage range, all of three switches 241 of the switch unit 240 are turned on so as to form a bypass circuit in all of three resistors 221 of the first resistor unit 220.

Herein, all of three resistors 221 of the first resistor unit 220 are separated from the circuit, and the second resistor unit 230 is only connected to both ends of the energy storage unit 211. Thus, the entire voltage stored in the energy storage unit 211 is supplied to the DC/DC converter 250 through the second resistor unit 230.

However, when the voltage detected in the energy storage unit 211 exceeds the preset voltage range and is smaller than a first reference voltage (first reference voltage<second reference voltage), two switches 241 of the switch unit 240 are turned on so as to form a bypass circuit in two resistors 221 among three resistors 221 of the first resistor unit 220. In other words, N is set to 3, and n is set to 2.

Herein, one resistor 221 and the second resistor unit 230 are connected to both ends of the energy storage unit 211 in parallel, and thus the voltage stored in the energy storage unit 211 is divided by the resistor 221 and the second resistor unit 230, and the divided voltage is input to the DC/DC converter 250.

When the voltage detected in the energy storage unit 211 exceeds the first reference voltage and is smaller than the second reference voltage that is higher than the first reference voltage, one switch 241 of the switch unit 240 is turned on so as to form a bypass circuit in one resistor among three resistors 221 of the first resistor unit 220. In other words, N is set to 3, and n is set to 1.

Herein, two resistors 221 and the second resistor unit 230 are connected to both ends of the energy storage unit 211 in parallel, and thus the voltage stored in the energy storage unit 211 is divided by the two resistors 221 and the second resistor unit 230, and the divided voltage is input to the DC/DC converter 250.

Herein, the division ratio decreases more as one resistor 221 is added, and thus the voltage input to the DC/DC converter 250 may be lowered even though the voltage detected in the energy storage unit 211 is increased more.

When the voltage detected in the energy storage unit 211 exceeds the second reference voltage, all of the switches 241 of the switch unit 240 are not turned on so as not to form a bypass circuit in three resistors 221 of the first resistor unit 220. In other words, N is set to 3, and n is set to 0.

Herein, three resistors 221 constituting the first resistor unit 220 and the second resistor unit 230 are connected to both ends of the energy storage unit 211 in parallel, and thus the voltage stored in the energy storage unit 211 is divided by the three resistors 221 and the second resistor unit 230, and the divided voltage is input to the DC/DC converter 250.

In other words, all resistors provided in the power supply 200 are used for voltage division so that the division ratio decreases more, and thus the voltage input to the DC/DC converter 250 satisfies a normal range by the voltage division even though an over voltage is detected in the energy storage unit 211.

As described above, the power supply 200 according to an embodiment of the present invention supplies driving power to the submodule controller by using the high voltage stored in the energy storage unit 211 provided in the submodule of the MMC converter. In addition, when an over voltage occurs in the high voltage, in order to satisfy the input voltage specification of the DC/DC converter 250, which receives the high voltage and converts the same into a low voltage, to be in a normal range, the power supply 200 operates the switches 241 of the switch unit 240 such that the voltage of the energy storage unit 211 is divided according to an over voltage degree of the energy storage unit 211 by using some resistors 221, which are selected from a plurality of resistors constituting the first resistor unit 220, and the second resistor unit 230. Thus, the DC/DC converter 250 receives the voltage that satisfies the normal range.

Accordingly, a power supply can be provided whereby damage due to an over voltage is prevented by using a conventional DC/DC converter without applying a DC/DC converter having a wide input voltage range in association with the over voltage that occurs in the conventional technique.

Although the present invention has been described in detail via the preferred embodiments, it should be noted that the present invention is not limited to the embodiments. It will be readily apparent to those having ordinary knowledge in the technical field to which the present invention pertains that various changes and modifications, which are not presented in the embodiments, can be made to the present invention within the scope of the attached claims and fall within the range of technical protection of the present invention. Accordingly, the scope of the disclosure is not to be limited by the above aspects but by the claims and the equivalents thereof.

1. A power supply for a submodule controller of an MMC converter, the power supply comprising:
a bridge circuit unit including an energy storage unit storing a DC voltage of a series-connected submodule of the MMC converter, and multiple power semiconductor devices connected in parallel to the energy storage unit in a bridge form;
a first resistor unit connected in parallel to the energy storage unit, and configured with at least one series-connected resistor;
a second resistor unit connected in series to the first resistor unit;
a switch unit connected in parallel to the first resistor unit; and
a DC/DC converter converting a voltage output from output terminals formed in both ends of the second resistor unit into a low voltage, and supplying the same to the submodule controller.

2. The power supply of claim 1, wherein when a voltage detected in the energy storage unit is equal to or smaller than a preset voltage, the switch unit is turned on so as to form a bypass circuit in the first resistor unit.

3. A power supply for a submodule controller of an MMC converter, the power supply comprising:
a bridge circuit unit including an energy storage unit storing a DC voltage of a series-connected submodule of the MMC converter, and multiple power semiconductor devices connected in parallel to the energy storage unit in a bridge form;
a first resistor unit configured with N series-connected resistors that are connected in parallel to the energy storage unit;
a second resistor unit connected in series to the first resistor unit;
a switching unit configured with N switches respectively connected in parallel to the N resistors constituting the first resistor unit; and
a DC/DC converter converting a voltage output from output terminals formed in both ends of the second resistor unit into a low voltage, and supplying the same to a submodule controller.

4. The power supply of claim 3, wherein n switches of the switching unit which are respectively connected in parallel to n resistors (n≤N) are turned on so as to form a bypass circuit in the n resistors among the N resistors constituting the first resistor unit according to a voltage detected in the energy storage unit.

5. The power supply of claim 4, wherein the n switches of the switching unit are turned on by setting an n value such that a number of the first resistors in which the bypass circuit is formed among the N resistors constituting the first resistor unit becomes smaller when the voltage detected in the energy storage unit is larger.

6. The power supply of claim 1, wherein the bridge circuit includes one of a half bridge circuit or a full bridge circuit.

7. The power supply of any one of claim 3, wherein the bridge circuit includes one of a half bridge circuit or a full bridge circuit.
